(19) United States
(12) Patent Application Publication
(10) Pub. No.: US 2013/0007013 A1
(43) Pub. Date: Jan. 3, 2013

(54) MATCHING USERS OVER A NETWORK

(75) Inventors: Kevin Geisner, Mercer Island, WA (US); Relja Markovic, Seattle, WA (US); Stephen Latta, Seattle, WA (US)

(73) Assignee: MICROSOFT CORPORATION, Redmond, WA (US)

(21) Appl. No.: 13/174,244

(22) Filed: Jun. 30, 2011

(51) Int. Cl. G06F 17/30

(52) U.S. Cl. 707/748; 707/E17.058

(57) ABSTRACT

Various embodiments are disclosed that relate to negatively matching users over a network. For example, one disclosed embodiment provides a method including storing a plurality of user profiles corresponding to a plurality of users, each user profile in the plurality of user profiles including one or more user attributes, and receiving a request from a user for a list of one or more suggested negatively matched other users. In response to the request, the method further includes ranking each of a plurality of other users based on a magnitude of a difference between one or more user attributes of the user and corresponding one or more user attributes of the other user, and sending a list of one or more negatively matched users to the exclusion of more positively matched users based on the ranking.

### BACKGROUND

In multi-player game play, different players may be matched together to participate in a game according to various matchmaking approaches. In one approach, players with comparable skill levels are matched in a game to compete against each other. For example, two players with “beginner” skill levels may be matched against one another to foster even competition, while experts may be matched together to ensure that both have a challenging experience.

### SUMMARY

Various embodiments are disclosed that relate to negatively matching users over a network. For example, one disclosed embodiment provides a method comprising storing a plurality of user profiles corresponding to a plurality of users, each user profile in the plurality of user profiles including one or more user attributes. The method further comprises receiving a request from a user for a list of one or more suggested negatively matched other users, and, in response to the request, ranking each of a plurality of other users based on a magnitude of a difference between one or more user attributes of the user and corresponding one or more user attributes of the other user, and sending a list of one or more negatively matched users to the exclusion of more positively matched users based on the ranking

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example interaction of matched users over a network according to an embodiment of the disclosure.

FIG. 2 shows an embodiment of a networked computing gaming environment in accordance with the disclosure.

FIG. 3 shows an embodiment of a method of negatively matching users over a network.

FIG. 4 shows another embodiment of a method of negatively matching users over a network.

FIG. 5 shows a block diagram depicting an embodiment of a computing device in accordance with the disclosure.

### DETAILED DESCRIPTION

As mentioned above, in one approach to matching players for interactive play, players may be positively matched with others of similar abilities. However, sometimes a player may not desire an evenly competitive match or an opponent with a similar temperament. Instead, players may occasionally desire to be negatively matched with others for a greater or lesser challenge, to elicit a stronger emotional experience, and/or for other such reasons. For example, some players or teams of players may desire to get into games with people they can dominate or are otherwise fun to beat. Likewise, a player may wish to occasionally play against a much better player to observe and learn the techniques of highly skilled opponents.

Accordingly, various embodiments are disclosed herein that relate to negatively matching players for online multi-player game play. The disclosed embodiments allow players to be negatively matched based upon attributes of game play that negatively correlate with the same attributes of other players. Any suitable attributes may be tracked and compared to perform such negative matching. For example, players may be negatively matched based upon attributes that can be considered to be global in nature, such that they describe a property that is not specific to a relationship between particular players. Examples of such global attributes may include, but are not limited to, overall skills in all games played, overall experience level, as well as game-specific experience and expertise levels.

Likewise, players may be negatively matched based upon attributes that can be considered to be more “local” in nature, such that they describe a property that is specific to relationships between individual players. Examples of such local attributes include, but are not limited to, lopsided scoring differences in games with a particular player, negative emotional states when playing a game with a particular player (e.g. as detected via an image sensor in the game playing environment), and the like. Such local attributes may further be tracked based not only upon specific player relationships, but also upon specific games played with that specific player. For example, player A may consistently lose badly to player B in first person shooter games, yet may perform much better against player B in dance games. As such, player B may be suggested as a negative match for player A (and vice versa) for first person shooter games, but not for dance games. It will be understood that these scenarios are presented for the purpose of example, and are not intended to be limiting in any manner.

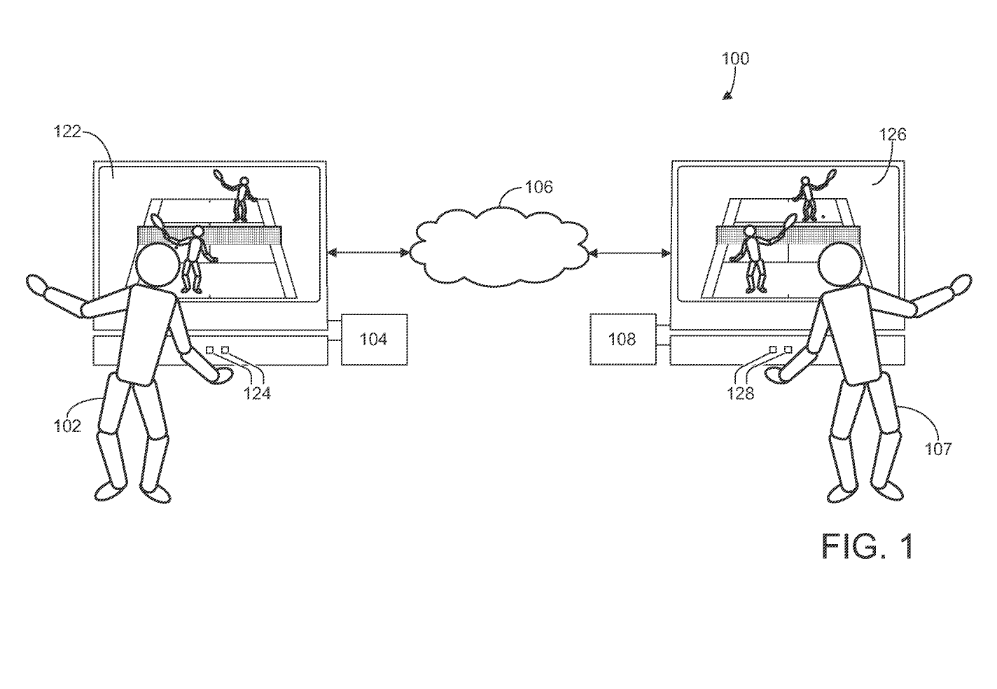

Prior to discussing such matching schemes, an example use environment is described with reference to FIG. 1, which shows an example use environment 100 in which matched users 102 and 107 are playing an interactive multi-player game over a network 106. Users 102 and 107 play the game via respective gaming systems 104 and 108 that are in communication with each other over network 106. User 102 views via a display 122 an avatar that represents user 108, and user 108 views via a display 126 an avatar that represents user 102. Actions of users 102 and 108 are detected respectively by sensors 124 and 128, which provide data to gaming systems 104 and 108 for interpretation as user inputs.

Gaming devices 104, 108 may be any suitable computing devices on which a game can be played and which connects to other devices over a network for interactive game play. For example, while gaming devices 104 and 108 are depicted as consoles configured to provide audio and/or video output to a display device such as a television or monitor, it will be understood that any other suitable gaming device may be used. Examples of suitable gaming devices include, but are not limited to, television-related gaming systems (e.g. game consoles, digital cable set-top boxes, satellite television set-top boxes, etc.), personal computing devices (e.g. desktop computers, laptop computers, notebook computers, tablet computers, etc.), mobile devices (e.g. smart phones, portable media players, handheld game consoles, etc.), or any other suitable computing device.

Sensors 124, 128 may represent any suitable user input sensors. Examples of sensors 124, 128 include, but are not limited to, natural user interface sensors such as audio sensors, e.g., microphones, video sensors, such as depth cameras or other image sensors, accelerometers and other motion sensors, biometric sensors (for measuring bioresponses), etc. With such input devices, various methods may be implemented to process data, signals, and measurements received by one or more sensors. For example, voice inflection, speech recognition, skeleton modeling, sound analysis, and various other methods may be used to process sensor data. Likewise, sensors 124, 128 may represent hand-held input devices such as game controllers, computer mice or other cursor control devices, joysticks, or other suitable input devices such as keyboards, etc.

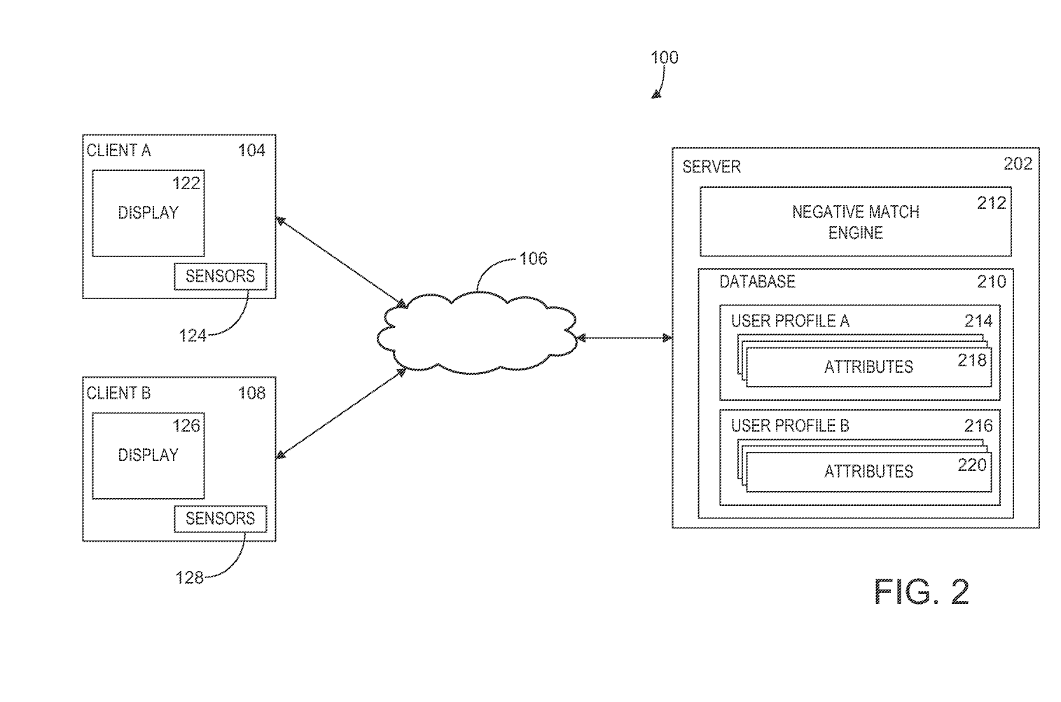

FIG. 2 shows a block diagram of use environment 100, and also illustrates a server 202 in communication with gaming systems 104, 108 via network 106. Server 202 comprises a negative matching engine 212 implemented as executable instructions on server 202, wherein negative matching engine 212 is configured to negatively match users for interactive play over network 206 based upon negative correlations between one or more user attributes of players being considered for matching. Negative matching engine 212 may enable players to locate and establish matches with players that result in lop-sided and/or contentious matches.

Server 202 includes or is otherwise in communication with a database 210. Database 210 is configured to store a plurality of user profiles, illustrated in FIG. 2 as a user profile 214 corresponding to a user of client device 104 and a user profile 216 corresponding to a user of client device 108. Each user profile may include a variety of user information for personalizing a game experience of a user.

For example, each user profile may include a plurality of attributes, illustrated in FIG. 2 as attributes 218 in user profile 214 and attributes 220 in user profile 216. Examples of user attributes include, but are not limited to, a friends list specifying friends or a social network of the user and a history of previous game play including a tracking of one or more attributes related to global game play characteristics as well as local game play characteristics as defined above. As more specific examples, attributes tracked in a user's game play history may include, but are not limited to, performance data regarding each game that the user has played, performance data regarding each other player that the user has played, emotional response data for games the user has played with specific other players, and other such data. Such data may then be used to track attributes, such as the above-mentioned attributes, related to a player's past performance and/or emotional responses with regard to specific games, specific players and /or specific game genres, as well as to analyze global attributes for that player.

As a more specific example, a player's experiences while playing a specific other user or users in a game match may be tracked. At the end of the match, the player's skill level mismatch may be weighted against all other players in that match, creating a localized ranking system. This data may be used in subsequent matching of users in the player's immediate and extended social network. For example, if the player plays against a friend and a friend of the friend and the friend of the friend always outperforms the player in a specific game, then the player and the friend of the friend may be classified as part of a negatively matched group for that particular game.

Identifying relative skill and/or temperament mismatches may further be based on a history of game play with other users. For example, if a first player has killed (e.g., beaten in races, solved puzzles faster than, dancing more songs better than, etc.) a second player more frequently than the second player has retaliated, then the first and second player may be classified in a negative match group even if they have comparable skill or temperament in a global ranking system (e.g., based on a general play style in all games).

The database 210 may store information global and/or local player attributes and use them to classify users in negative match groups. Further, the negative matching engine may perform different rankings for global and local attributes. The global and local ranking systems may be performed separately, or combined. Further a user may select which type of ranking to perform, or the ranking may be done automatically without user selection.

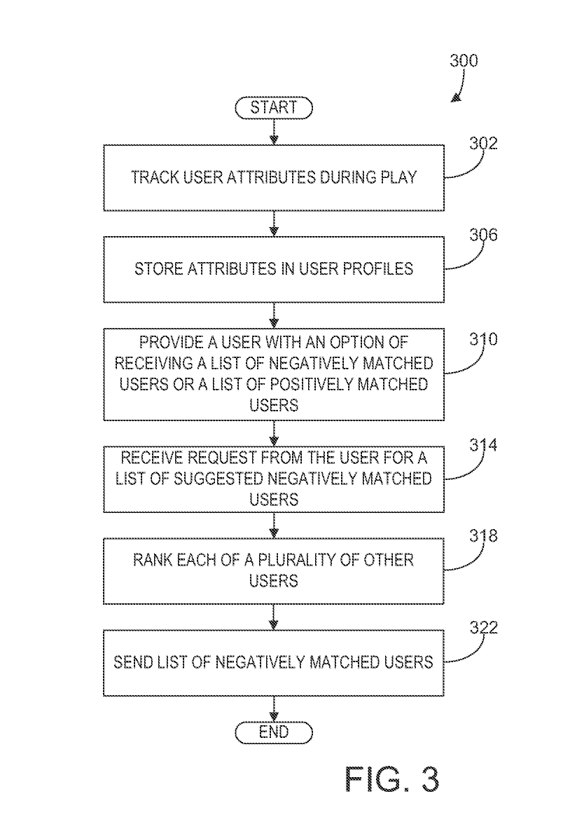

FIG. 3 shows an embodiment of a method 300 for matching users over a network. Method 300 may be used to negatively match users or teams of users with other users or other teams of users for game play. At 302, method 300 includes tracking user attributes during play and storing said interactions as a user attribute in each corresponding user profile. Such attributes may be tracked in any suitable manner. For example, various sensors on client devices may be used to track player interactions, emotional responses, etc. during game play for storage.

Any suitable attributes may be tracked and stored. For example, attributes such as emotional responses, personalities, and temperaments of a user as determined through detection of animated voice inflection, speech recognition, player posture changes, facial expression recognition, pupil dilation, voice volumes, text chat analysis, etc. may be tracked and stored while a user plays another user in a game. Likewise, skill levels and/or habits of a player in a game also may be tracked and stored. As yet other non-limiting examples, attributes such as points earned, scores achieved, death ratios, game contacts, and disparities when a user plays another user in a game may be tracked and stored.

Further, user experiences when playing with one or more specific other users may be tracked and stored as attributes which may be used to provide negative matches. For example, if a first user plays a friend and another user and the other user keeps outperforming the first user in a particular game, then the other user and the first user may be ranked as a negative match. As another example, if the first user displays negative facial expressions while playing with the other user, then the first user and the other user may be ranked as a negative match. Further, in some examples, the attributes used to negatively match users may depend on certain games or game genres, as mentioned above.

Further, in some examples, one or more user attributes of a select user may be predicting based on user attributes of users similar to said select user or based on other known user attributes of the select user. For example, attributes of a new user may be predicted based on the new user's friends. Further, predictions may be based on age, geography, game scores, etc. to predict unknown attributes. It will be understood that the term “tracking” as used herein also may include such predicting of attributes.

At 306, method 300 includes storing a plurality of user profiles corresponding to a plurality of users, where each user profile in the plurality of user profiles includes one or more user attributes. In some examples, the user attributes stored in a user profile may be based on the interaction tracking at step 302 and may include a user skill level in a game, a negative user emotional response in one or more past games with another user, and/or any other suitable user data which may be used in a matchmaking scheme. Additionally, in some examples, a user may provide inputs of one or more attributes to be stored. For example, a user may input feedback data describing or rating an interaction with another user.

At 310, method 300 comprises providing the user with an option of receiving a list of one or more negatively matched users or a list of one or more positively matched users. The option may be presented to a user in any suitable manner, such as via a display.

Next, at 314, in response to presenting the user the option to receive negative or positive matches, method 300 includes receiving a request for a list of one or more suggested negatively matched other users. Then, at 318, method 300 includes ranking each of a plurality of other users based on a magnitude of a difference between one or more user attributes of the user and corresponding one or more user attributes of the other user. For example, each of a plurality of other users may be ranked so that a list of one or more negatively matched users comprising a greater mismatch in skill level or emotional response than the more positively matched users may be generated.

The ranking may be performed by negative matching engine 212, for example, and may take into account various user attributes stored in user profiles in database 210. In some examples, the ranking may be a based on certain user attributes to the exclusion of other user attributes depending on a variety of factors including the particular game or type of game being played, a user selection of the types of attributes to consider in the ranking, user attributes of the user initiating the game, etc.

In some embodiments, ranking each of a plurality of other users at 318 may further include various other prioritization schemes. For example, users in a friends list of the user may be prioritized in the ranking over those users not in the user's friend list. As another example, users who have previously played the user in a game may be prioritized in the ranking over those users who the user has not previously played. Further, in some examples, a user may specify a prioritization scheme to include in the ranking For example, a user may input specific criteria, such as age, sex, location, etc., to be considered in the ranking It will be understood that these examples are not intended to be limiting, as any other suitable factors may be used in ranking other users.

At 322, method 300 includes sending a list of one or more negatively matched users to the exclusion of more positively matched users based on the ranking. For example, the list may include a top number of negative matches from which the user may choose. In other embodiments, the user may be automatically matched with a user, e.g., a most negatively ranked user, a moderately negatively matched user, etc.

As remarked above, method 300 may be implemented by multiple users or teams to negatively match up a plurality of users with another user. In such a case, user attributes may be aggregated when used in the ranking step. For example, common attributes of the plurality of players may be used during the ranking In this way, a plurality of users may be able to team up against a common enemy to get revenge, for example.

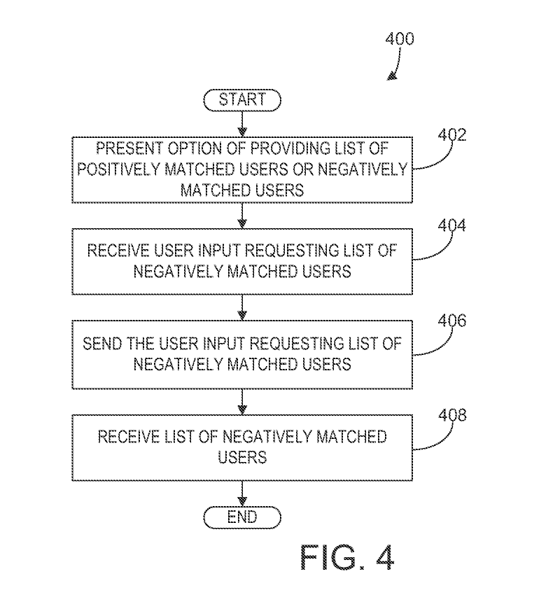

FIG. 4 shows another embodiment of a method 400 for matching users over a network is shown. Method 400 is described from the point of a view of a client device of a user seeking negative matches for game play. At 402, method 400 includes presenting on a computing device display an option of providing a list of suggested positively matched users or a list of suggested negatively matched users. At 404, method 400 includes receiving from a user input device a user input requesting the list of suggested negatively matched users. The input may be received from any suitable user input device. Examples include, but are not limited to, a game controller, a keyboard, an image sensor, a depth sensor, an audio sensor, and combinations thereof.

After receiving the input, method 400 includes, at 406, sending to a remote server the request for the list of suggested negatively matched users. Then, at 408, method 400 includes receiving from the remote server the list of suggested negatively matched users to the exclusion of more positively matched users based on a ranking of each of a plurality of other users, wherein the one or more negatively matched users comprise a greater mismatch in skill level and/or emotional response than the more positively matched users. A user may then choose a player from the list to initiate game play with the player.

As remarked above, the ranking to determine suggested negative matches may be based on a magnitude of differences between one or more user attributes of the user and corresponding one or more user attributes of the other user. Examples include, but are not limited to, skill levels of the users in the requested game and past interactions between the requesting user and the other users, such as scoring disparities and/or emotional responses). In this manner, a user seeking an emotionally charged game, a lopsided game, etc. can easily locate other players with which to enjoy such play.

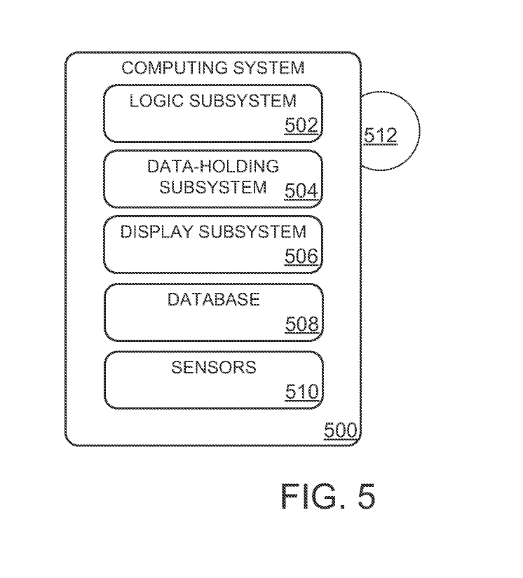

As mentioned above, the embodiments disclosed herein may be implemented on any suitable computing device. FIG. 5 schematically shows a nonlimiting representative computing device 500 that may perform one or more of the above described methods and processes. Computing device 500 is shown in simplified form. It is to be understood that virtually any computer architecture may be used without departing from the scope of this disclosure. In different embodiments, computing device 500 may take the form of a mainframe computer, server computer, desktop computer, laptop computer, tablet computer, home entertainment computer, network computing device, mobile computing device, mobile communication device, gaming system, etc.

Computing device 500 includes a logic subsystem 502 and a data-holding subsystem 504. Computing device 500 may optionally include a display subsystem 506, database 508, a sensor system 510, and/or other components not shown in FIG. 5. Computing device 500 may also optionally include other user input devices than sensor system 510, such as keyboards, mice, game controllers, cameras, microphones, and/or touch screens, for example.

Logic subsystem 502 may include one or more physical devices configured to execute one or more machine-readable instructions. For example, logic subsystem 502 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 502 may include one or more processors that are configured to execute software instructions. Additionally or alternatively, logic subsystem 502 may include one or more hardware or firmware logic machines configured to execute hardware or firmware instructions. Processors of logic subsystem 502 may be single core or multicore, and the programs executed thereon may be configured for parallel or distributed processing. Logic subsystem 502 may optionally include individual components that are distributed throughout two or more devices, which may be remotely located and/or configured for coordinated processing. One or more aspects of logic subsystem 502 may be virtualized and executed by remotely accessible networked computing devices configured in a cloud computing configuration.

Data-holding subsystem 504 may include one or more physical, non-transitory, devices configured to hold data and/or instructions executable by the logic subsystem to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 512, which may be used to store and/or transfer data and/or instructions executable to implement the herein described methods and processes. Removable computer-readable storage media 512 may take the form of CDs, DVDs, HD-DVDs, Blu-Ray Discs, EEPROMs, and/or floppy disks, among others.

When included, display subsystem 506 may be used to present a visual representation of data held by data-holding subsystem 504. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, database 508 may be configured to store various user profile information which may be queried and ranked as described above. When included, sensor system 510 may include various sensor devices, such as audio capture devices, video or image capture devices, accelerometers, motion sensors, biometric sensors, etc. which may be used to capture interactions of a user with computing device 500 and transmit the sensor data over a network or to logic subsystem 502 for processing.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for matching users over a network, the method comprising:
storing a plurality of user profiles corresponding to a plurality of users, each user profile in the plurality of user profiles including one or more user attributes;
receiving a request from a user for a list of one or more suggested negatively matched other users;
in response to the request, ranking each of a plurality of other users based on a magnitude of a difference between one or more user attributes of the user and corresponding one or more user attributes of the other user; and
sending a list of one or more negatively matched users to the exclusion of more positively matched users based on the ranking

2. The method of claim 1, wherein the one or more user attributes include a user skill level in a game, and wherein the one or more negatively matched users comprise a greater mismatch in skill level than the more positively matched users.

3. The method of claim 1, wherein the one or more user attributes include a negative user emotional response in one or more past games with another user, and wherein the one or more negatively matched users comprise a greater magnitude of negative emotional response in the past games than the more positively matched users.

4. The method of claim 3, wherein the user emotional response is based on a sensor measurement.

5. The method of claim 1, further comprising tracking interactions between the user and other users in the plurality of users and storing said interactions as a user attribute in each corresponding user profile.

6. The method of claim 1, further comprising predicting a user attribute of a select user based on user attributes of users similar to said select user.

7. The method of claim 1, further comprising prioritizing users who have previously played the user in a game in the list of one or more negatively matched users sent to the user.

8. The method of claim 1, wherein each user profile includes a friends list, and further comprising prioritizing other users in a friends list of the user in the list of one or more negatively matched users sent to the user.

9. The method of claim 1, wherein receiving the request for the list of one or more suggested negatively matched users comprises providing an option of receiving a list of one or more negatively matched users or a list of one or more positively matched users.

10. A method for matching users over a network, the method comprising:
presenting on a computing device display an option of providing a list of suggested positively matched users or a list of suggested negatively matched users;
receiving from a user input device a user input requesting the list of suggested negatively matched users;
sending to a remote server a request for the list of suggested negatively matched users; and
receiving from the remote server the list of suggested negatively matched users to the exclusion of more positively matched users based on a ranking of each of a plurality of other users.

11. The method of claim 10, wherein the ranking is based on a magnitude of differences between one or more user attributes of the user and corresponding one or more user attributes of the other user.

12. The method of claim 10, wherein the one or more user attributes include a user skill level in a game, and wherein the one or more negatively matched users comprise a greater mismatch in skill level than the more positively matched users.

13. The method of claim 10, wherein the one or more user attributes include a negative user emotional response in one or more past games with another user, and wherein the one or more negatively matched users comprise a greater magnitude of negative emotional response in the past games than the more positively matched users.

14. The method of claim 13, further comprising receiving an input of sensor data, and detecting the negative user emotional response from the sensor data.

15. The method of claim 14, wherein the input received from the sensor comprises one or more of an audio signal and a video signal.

16. The method of claim 14, wherein the sensor measurement includes a measurement of a bioresponse of the user.

17. The method of claim 10, wherein the ranking is based on a magnitude of differences between at least one user attribute of the user and a corresponding user attribute of a user similar to the other user.

18. A computing device, comprising:
a logic subsystem; and
a data holding subsystem comprising machine-readable instructions stored thereon that are executable by the logic subsystem to:
present on a computing device display an option of providing a list of suggested positively matched users or a list of suggested negatively matched users;
receive from a user input device a user input requesting a list of suggested negatively matched users;
send to a remote server a request for the list of suggested negatively matched users; and
receive from the remote server the list of suggested negatively matched users to the exclusion of more positively matched users based on a ranking of each of a plurality of other users, the ranking based on a magnitude of differences between one or more user attributes of the user and corresponding one or more user attributes of the other user.

19. The computing device of claim 18, wherein the one or more user attributes include a user skill level in a game, and wherein the one or more negatively matched users comprise a greater mismatch in skill level than the more positively matched users.

20. The computing device of claim 18, wherein the one or more user attributes include a negative user emotional response in one or more past games with another user, and wherein the one or more negatively matched users comprise a greater magnitude of negative emotional response in the past games than the more positively matched users.
